(19) United States
(12) Patent Application Publication
(10) Pub. No.: US 2026/0136193 A1
(43) Pub. Date: May 14, 2026

(54) MOBILITY MANAGEMENT ANOMALY DETECTION IN WIRELESS NETWORKS

(71) Applicant: T-Mobile USA, Inc., Bellevue, WA (US)

(72) Inventors: Joseph A. Santor, Renton, WA (US); Maria Victoria Cabamalan, Covington, WA (US); Cesare Natale, Frisco, TX (US); Jonathan S. Ramirez, Frisco, TX (US)

(21) Appl. No.: 18/985,336

(22) Filed: Dec. 18, 2024

Related U.S. Application Data
(60) Provisional application No. 63/720,007, filed on Nov. 13, 2024.

(51) Int. Cl. H04W 12/121

(52) U.S. Cl. CPC H04W 12/121

(57) ABSTRACT

The system receives error code data from a plurality of network nodes configured to manage mobility in a telecommunications network. The error code data is associated with signaling procedures of the plurality of network nodes configured to manage mobility in the telecommunications network. The system identifies, using one or more machine learning models, one or more error codes in the error code data associated with one or more procedure types of signaling procedures. The system determines an anomaly score for each of the one or more identified error codes. The anomaly score indicates a measure of occurrences of the error code as compared to an anomaly threshold value. The system calculates, based on the anomaly threshold value and the anomaly score, a severity score for each of the one or more identified error codes.

### CROSS-REFERENCE TO RELATED APPLICATION

The application claims priority to U.S. Provisional Pat. App. No. 63/720,007 filed Nov. 13, 2024, titled Mobility Management Anomaly Detection in Wireless Networks, which is hereby incorporated by reference in its entirety.

### BACKGROUND

Wireless communication networks enable mobile devices to connect and exchange data over radio frequencies. These networks typically consist of base stations that provide coverage to geographic areas, core network infrastructure to manage connections and routing, and end-user devices like smartphones. Modern cellular networks have evolved through multiple generations, from early analog systems to current 5G networks supporting high-speed data and low-latency applications.

Access and mobility management are key functions in cellular networks that handle device authentication, tracking of device locations, and maintaining connectivity as users move between coverage areas. These functions are performed by specialized network elements such as the Mobility Management Entity (MME) in 4G networks and the Access and Mobility Management Function (AMF) in 5G networks. As devices connect, disconnect, and move throughout the network, these elements process signaling messages and maintain state information to enable seamless service.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 illustrates a block diagram of an example mobility management anomaly detection process in accordance with one or more embodiments of the present technology.

FIG. 4A illustrates a block diagram of an example error code classification at an AMF in accordance with one or more embodiments of the present technology.

FIG. 4B illustrates a block diagram of an example of error code classification at an MMF in accordance with one or more embodiments of the present technology.

FIG. 5 illustrates an example line graph of mobility management anomaly detection in accordance with one or more embodiments of the present technology.

FIG. 6 illustrates a flowchart for a method of training one or more machine learning models for use in a communication network in accordance with one or more embodiments of the present technology.

FIG. 7 illustrates a flowchart of a method for detecting mobility management anomalies in accordance with one or more embodiments of the present technology.

FIG. 8 is a block diagram illustrating an example machine learning (ML) system in accordance with one or more embodiments.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to techniques for detecting anomalies in error codes generated from mobility management network nodes of a telecommunications network. A system implementing the disclosed techniques can detect the anomalies using one or more machine learning (ML) models. The system collects historical error codes to create a training dataset. For example, historical error codes can be generated for the previous week, month, quarter, year, etc. The system processes the historical error codes by grouping each error code by procedure type and categorizing each grouped procedure type based on the frequency at which each error code occurs. Processing the data in this way enables the system to detect low-magnitude error code frequencies—for example, frequencies of zero to one per queried dataset. The system uses the training dataset and/or a supplemental training dataset to train one or more ML models. The supplemental training dataset can include known anomalies in the error codes. When the ML model is trained, the system can use the ML model to detect anomalies in the error codes generated by the mobility management network nodes, such as those at the AMF and/or MME. The system receives the error code data and identifies one or more error codes in the error code data. The system determines an anomaly score for each error code and then uses a predetermined anomaly threshold value to calculate a severity score for each error code. The system can display the severity code to a user so that each anomaly can be addressed and any service issues faced by subscribers can be fixed.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

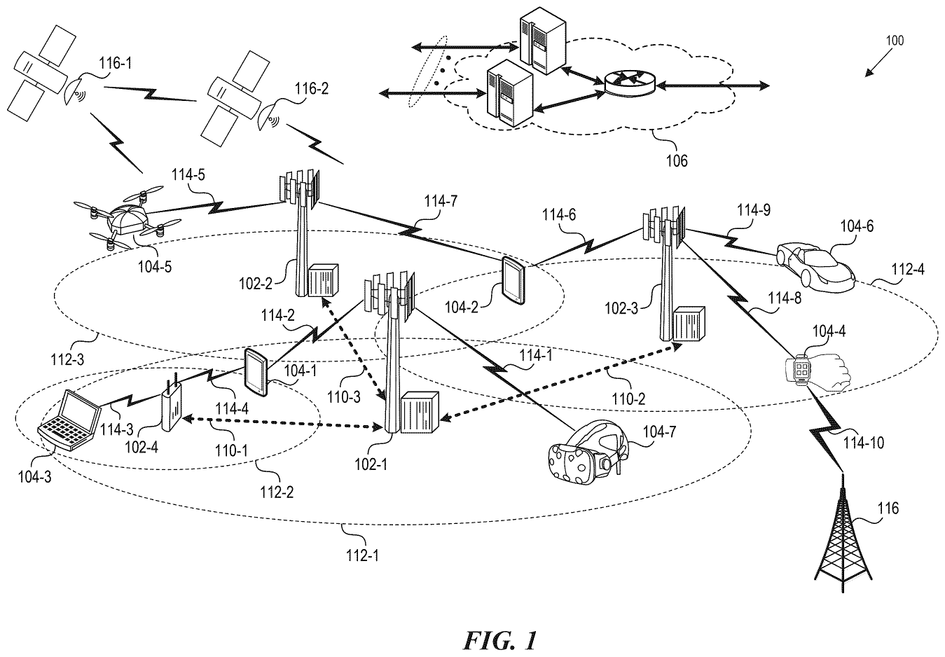

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies, including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

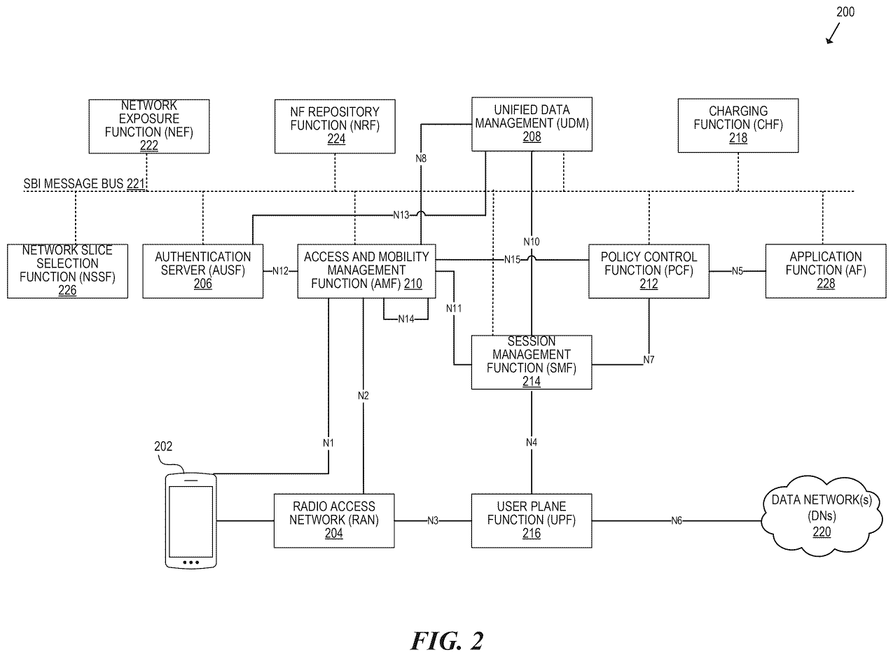

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Mobility Management Error Detection

In wireless communication networks, the mobility management network nodes handle tasks such as device authentication, location tracking, and maintaining connectivity as users move between coverage areas. Hundreds of error codes associated with different signaling procedure types are generated at the mobility management network nodes across different host groups, market regions, and nationwide operations. The error codes can be generated by the Mobility Management Entity (MME) for 4G networks and the Access and Mobility Management Function (AMF) for 5G networks. The number of error codes can range from zero to thousands per minute depending on the procedure types associated with the error codes and/or the time of day. Conventional methods of detecting the error codes often only indirectly provide insight into the error codes. These existing methods do not provide sufficient insight into whether an error code is causing subscribers to experience service issues.

Some existing detection methods leverage ML models to perform the detection. However, off-the-shelf ML models struggle to detect and differentiate anomalies given the range of magnitudes in the number and frequency of error codes for each procedure type. Existing ML models are unable to detect patterns at each level (e.g., host group, market, region, pool, and nationwide). In addition, the existing models often treat low-count error codes as noise, which results in an inability to determine specific error codes and combinations of error codes that are indicative of issues affecting the subscribers'user experience. Therefore, conventional methods and ML models do not enable effective real-time detection of anomalies in error codes generated from mobility management network nodes.

This patent document discloses techniques that can be implemented in various embodiments to generate suitable training datasets for detection of error codes from mobility management nodes for the ML models such that the models are trained to recognize different error codes associated with different procedure types and are able to distinguish the severity of certain errors.

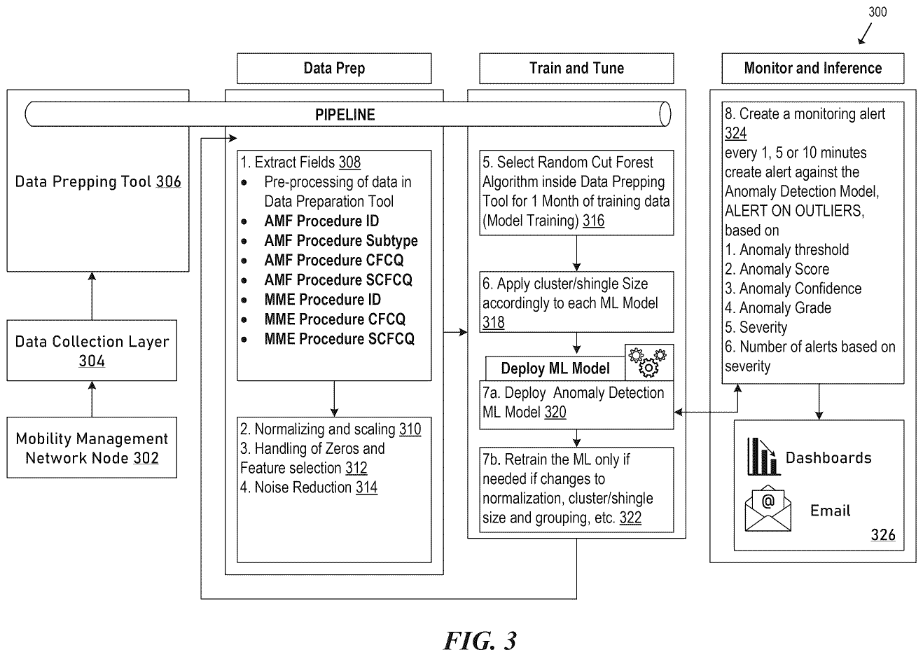

FIG. 3 illustrates a block diagram of an example mobility management anomaly detection process 300 in accordance with one or more embodiments of the present technology. The anomaly detection process 300 includes at least operations for data collection, data preparation, ML model training, and error code monitoring. At operation 302, error code data is generated by the mobility management network node. The mobility management network node can include the AMF for 5G networks and/or the MME for 4G networks. At operation 304, the system collects the error code data at the data collection layer from the mobility management network node. At operation 306, the system receives the error code data using a tool for data preparation. The data preparation tool is used to generate a training dataset used to train the one or more ML models included in the system. In some embodiments, data processing is performed on new error code data to better determine the existence of an anomaly in the new error code data.

At operation 308, the system groups the error codes by procedure types. The system groups the error codes by extracting fields using techniques such as data cleansing and/or data structuring and/or preprocesses the data using the data preparation tool. The procedure types can be specific to the mobility management network node types. For example, the procedure types can be AMF procedure ID, AMF procedure subtype, AMF procedure Call Final Class Qualifier (CFCQ), AMF procedure Supplemental CFCQ (SCFCQ), MME procedure ID, MME procedure subtype, MME procedure CFCQ, and/or MME procedure SCFCQ. At operation 310, the system normalizes and scales the grouped error codes into different categories based on the frequency at which the error code occurs. Specific error codes for certain procedure types occur in much higher frequencies than others (e.g., thousands per minute compared to zero to ten per minute on average). For example, the groups can be categorized into categories labeled “very high count (VHC),” “high count (HC),” “medium count (MC),” and/or “low count (LC).” At operation 312, the system handles zeros and performs a feature selection. Some error codes, on average, have zero or near-zero counts over a typical predetermined timer period, such as one, five, or ten minutes. The system uses feature selection or dimensionality reduction to manage the presence of zeros and reduce the complexity of the input data. Because the error codes are grouped by frequency, the system can determine, for example, that an error code in LC typically has a near-zero frequency and should not be removed as noise. In some embodiments, the system assigns a threshold or average value to each category to indicate a standard frequency for an error code. The dimensionality prevents zero-frequency error codes from being missed or removed by the ML model. At operation 314, the system performs noise reduction. Noise reduction is accomplished by adjusting the cluster/shingle size depending on the frequency category for classification. For example, the system can use larger clusters or shingles for VHC and HC (e.g., 3-5) and smaller ones for MC and LC (e.g., 5). Adjusting the cluster/shingle size smooths noisy data and improves the detection accuracy of the system.

At operation 316, the system trains each ML model using the error codes processed in the data preparation tool. In some embodiments, the ML model uses the random cut forest algorithm to detect anomalous data points within a dataset. The generated training dataset can include error code data from the previous week, month, or year. Training the ML model enables the system to detect anomalies in the error code data. At operation 318, the system applies one or more cluster/shingle size(s) according to each ML model. The cluster/shingle size can be unique to each ML model in the system and/or can vary based on the procedure type assigned to each error code. At operation 320, the system deploys the one or more anomaly detection ML models. In some embodiments, one ML model can be deployed for multiple procedure types. In some embodiments, different ML models can be used for different procedure types. At operation 322, the system can retrain an ML model as needed. For example, retraining can be required to renormalize the error code groups, adjust the cluster/shingle size of a category, and/or modify the groupings themselves.

At operation 324, the system can create a monitoring alert based on a detected anomaly in a query. A query including new error code data can occur, for example, every 1, 5, or 10 minutes. Therefore, an alert can be generated at the same interval as a query. The interval at which an alert is generated can depend on the frequency at which the system receives new error code data. The system generates an alert when the ML model detects an anomaly. An anomaly indicates an outlier in the error code data. An outlier can be based on an anomaly threshold, an anomaly score, an anomaly confidence score, the severity of the anomaly, and/or the number of alerts based on the severity score. The anomaly threshold can be determined by the ML model based on the training dataset. The anomaly threshold represents the total number of error codes that must be reached for an anomaly to be deemed as having occurred. The anomaly score is calculated by the ML model using the new error code data and represents how far away the total number of error codes in the query is from the anomaly threshold. The confidence score represents the likelihood that the anomaly score, severity score, etc. are within the parameters set by the ML model. The ML model can compare the error code data against predetermined values. For example, the system can filter for anomaly grades above 0.9 and anomaly confidence scores of 0.7 and above. This enables the system to identify selective error codes across various entities such as hosts, regions, markets, MME, AMF, and other available dimensions. The severity score of an anomaly is calculated by dividing the anomaly score by the anomaly threshold. Therefore, the severity is classified based on the severity ratio. For example, a low severity can be less than 1.5, a medium severity can be between 1.5 and 2, a high severity can be between 2 and 3, and a critical severity can be above 3. In some embodiments, an alert is triggered based on the calculated severity score. At operation 326, the alert is transmitted to a user. The alert can be in the form of a dashboard to display the anomaly threshold, an anomaly score, an anomaly confidence value, an anomaly grade, a severity score, and/or the number of alerts based on the severity score. In some embodiments, the alert is emailed to a user. In some embodiments, the alert includes a link to the dashboard.

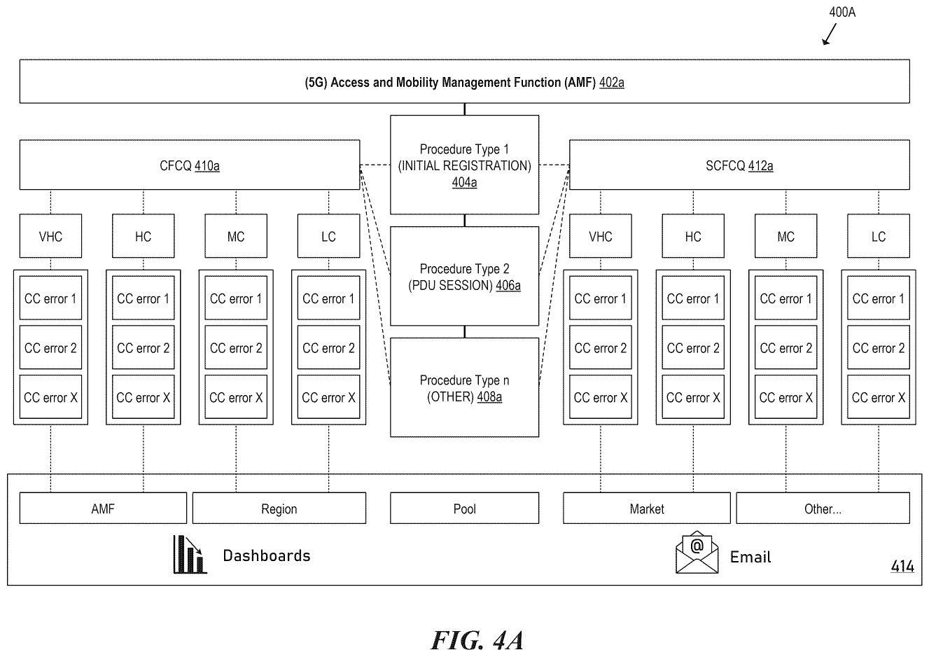

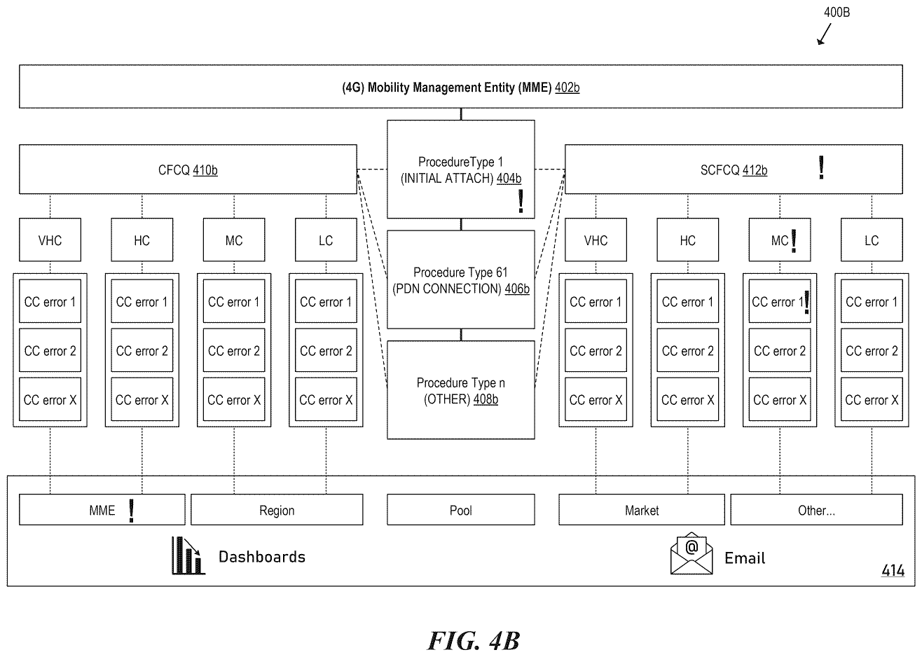

FIG. 4A illustrates a block diagram 400a of an example error code classification at an AMF 402a in accordance with one or more embodiments of the present technology. The AMF 402a can have multiple different procedure types. For example, procedure type 1 404a can be for initial registration error codes, procedure type 2 406a can be for packet data unit (PDU) session error codes, and procedure type n 408a can be for any possible procedure type. Procedure types related to the CFCQ can be classified under CFCQ 410a. Each procedure type is categorized by frequency (e.g., VHC, HC, MC, or LC). Each frequency category can include multiple error codes, such as continuity count (CC) error 1, CC error 2, CC error X, etc. Additionally, procedure types related to the SCFCQ can be classified under SCFCQ 412a. Each procedure type is categorized by frequency (e.g., VHC, HC, MC, or LC). Each frequency category can include multiple error codes, such as CC error 1, CC error 2, CC error X, etc. Each error code at the CFCQ 410a and SCFCQ 412a can be identified across various entities (e.g., AMF, region, pool, market, etc.) using the dashboard 414. When no anomaly is detected, no alert is displayed on the dashboard 414, and the dashboard does not send an email.

FIG. 4B illustrates a block diagram 400b of an example of error code classification at an MME 402b in accordance with one or more embodiments of the present technology. The MME 402b can have multiple different procedure types. For example, procedure type 1 404b can be for initial attachment error codes, procedure type 61 406b for public data network (PDN) error codes, and procedure type n 408b for any possible procedure type. Procedure types related to the CFCQ can be dimensioned under CFCQ 410b. Each procedure type is categorized by frequency (e.g., VHC, HC, MC, or LC). Each frequency category can include multiple error codes, such as continuity count (CC) error 1, CC error 2, CC error X, etc. Additionally, procedure types related to the SCFCQ can be classified under SCFCQ 412b. Each procedure type is categorized by frequency (e.g., VHC, HC, MC, or LC). Each frequency category can include multiple error codes, such as CC error 1, CC error 2, CC error X, etc. For example, the system can determine the existence of an anomaly for the CC error 1 under the MC category of the SCFCQ 412b. Each error code at both the CFCQ 410b and SCFCQ 412b can be identified across various entities (e.g., AMF, region, pool, market, etc.) using the dashboard 414 or email alert. Because an anomaly was detected at the SCFCQ 412b, the system can generate an alert at the dashboard 414 to indicate the anomaly threshold, the anomaly score, the anomaly confidence value, the anomaly grade, the severity of the anomaly, and/or the procedure type of the anomaly. The dashboard 414 can generate an email to alert the user of the anomaly. The email can include the same information as the dashboard 414.

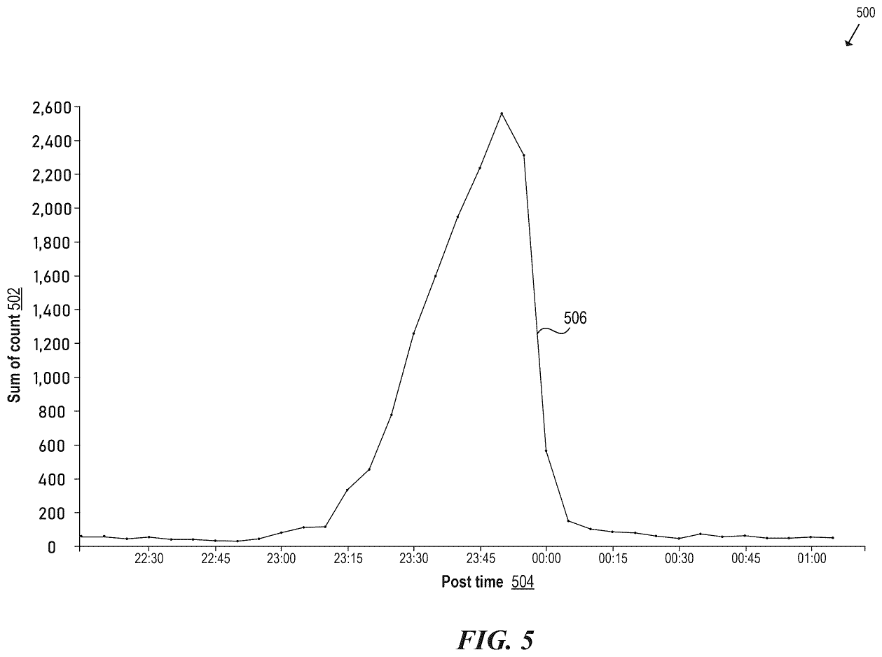

FIG. 5 illustrates an example line graph 500 of mobility management anomaly detection in accordance with one or more embodiments of the present technology. The graph's X-axis can represent the sum of the count 502, which represents the total number of error codes for the procedure type. The Y-axis of the graph can represent the post time 504. The post time 504 is the time period when the error codes were generated. The post time can be in predefined intervals, such as every 5, 10, or 15 minutes. The error codes can be represented as line 506. For example, the error codes can be a part of the AMF Production type 2 PDU. From time 22:30 until time 23:00, the number of error codes can be constant at a low number, and then from time 23:15 to 23:45, the number of error codes can spike before returning to the previously low constant number at time 00:15. The spike can represent an anomaly. For example, the anomaly can have the following details that are recorded by the system:
Anomaly threshold: 0.81859
Anomaly score: 2.55503
Anomaly grade: 1.0
Confidence score: 1.04326
Severity level: Critical

The anomaly threshold can be derived using the ML model and random cut forest algorithm. In some embodiments, the anomaly threshold is based on a one-month training data cutoff score for data points considered anomalous. The anomaly score can be derived using the ML model and the random cut forest algorithm, and newly received data. The anomaly score can be determined by comparing the distance the newly received data is from the anomaly threshold. For example, a higher value can indicate a more significant outlier and anomaly. The anomaly grade can be derived using the ML model and the random cut forest algorithm. The anomaly grade can be between zero and one, where a value of one indicates the most significant anomaly. The confidence score can be derived using the ML model and the random cut forest algorithm. The confidence score can have a value greater than one, where a value of one or more indicates the highest possible anomaly classification. The severity score is determined by dividing the anomaly score by the anomaly threshold. For example, the severity score can be displayed as critical, non-critical, etc. Based on the anomaly details, the system can determine that an alert should be generated. For example, the AMF Production type 2 PDU can have a failure threshold of 1100, meaning that an alert is generated when the system detects more than 1100 error codes for that production type within a predetermined period.

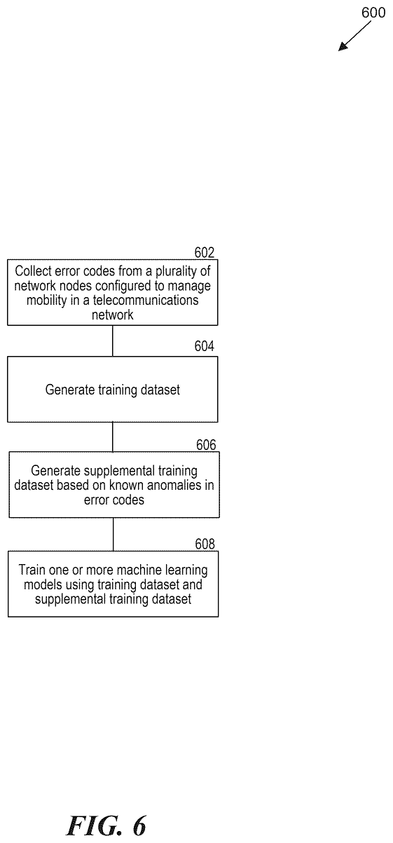

FIG. 6 illustrates a flowchart for a method of training one or more machine learning models for use in a communication network in accordance with one or more embodiments of the present technology. At operation 602, the system collects error codes from a plurality of network nodes configured to manage mobility in a telecommunications network. The error codes indicate errors associated with signaling procedures in connection with the plurality of network nodes within a predetermined time period. In some embodiments, the plurality of network nodes includes an access and mobility management function (AMF) or a mobility management entity (MME).

At operation 604, the system generates a training dataset. To generate the training dataset, the system can group the error codes based on one or more procedure types of the signaling procedures and categorize the grouped error codes into different categories based on frequencies of occurrences of the error codes. In some embodiments, categorizing the grouped error codes further comprises calculating an average frequency of each error code production type for each category, where the average frequency is greater than or equal to zero. The grouped error codes can be categorized as very high count, high count, medium count, and low count. The average frequency for each error code varies by production type. In some other embodiments, generating the training dataset further comprises adjusting a cluster/shingle size for the training dataset based on the dimensioned group to enable noise reduction in the error code data. In some examples, the system can train the one or more machine learning models to calculate a severity score for each error code. The severity score is indicative of an instance of an anomaly in the error code data. In some other examples, the system can train the one or more machine learning models to calculate an anomaly threshold value for each production type and train the one or more machine learning models to calculate an anomaly score for each error code. The severity score is calculated using the anomaly threshold value and the anomaly score.

At operation 606, the system generates a supplemental training dataset based on known anomalies in the error codes. At operation 608, the system trains the one or more machine learning models using the training dataset and the supplemental training dataset. In some embodiments, the machine learning model uses a random cut forest algorithm.

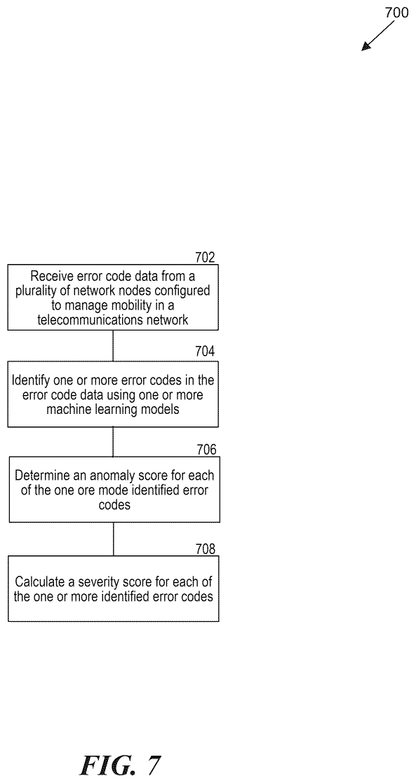

FIG. 7 illustrates a flowchart of a method for detecting mobility management anomalies in accordance with one or more embodiments of the present technology. In one example, the system includes at least one hardware processor and at least one non-transitory memory storing instructions, which, when executed by the at least one hardware processor, cause the system to perform the process 700.

At operation 702, the system receives error code data from a plurality of network nodes configured to manage mobility in a telecommunications network. The error code data is associated with signaling procedures in connection with the plurality of network nodes configured to manage mobility in the communication network. In some embodiments, the plurality of network nodes includes an access and mobility management function (AMF) or a mobility management entity (MME). At operation 704, the system identifies one or more error codes in the error code data using one or more machine learning models. The one or more machine learning models are trained to determine a frequency of occurrence of an error code by grouping error codes based on one or more procedure types associated with the signaling procedures in connection with the plurality of network nodes and classifying the grouped error codes into different categories based on frequencies of occurrences of the error codes. In some embodiment, the one or more machine learning models are further trained to calculate an average frequency of each error code production type for each category, where the average frequency is greater than or equal to zero. The one or more machine learning models can be further trained to calculate the anomaly threshold value based on the calculated average frequency for each error code production type.

At operation 706, the system determines an anomaly score for each of the one or more identified error codes. The anomaly score indicates a measure of occurrences of the error code as compared to an anomaly threshold value. At operation 708, the system calculates, based on the anomaly threshold value and anomaly score, a severity score for each of the one or more identified error codes. In some embodiments, calculating the severity score further causes the system to divide the anomaly score by the anomaly threshold value. In some other embodiments, the system categorizes the severity score based on the severity indicated by the severity score. The system can generate an alert based on the category of severity score. In some other embodiments, the system generates a dashboard including the anomaly threshold value, anomaly score, or severity score for each grouped error code and causes display of the dashboard to a user.

### Machine Learning Model

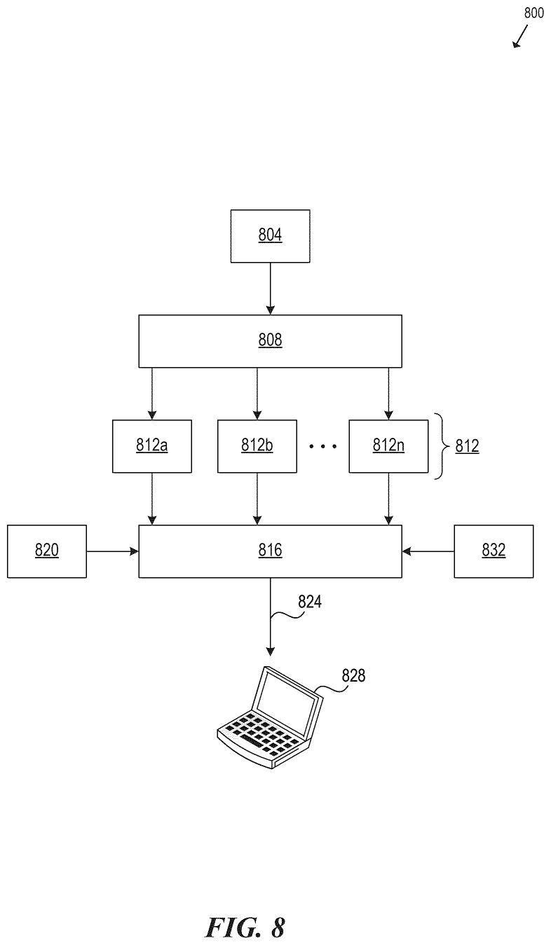

FIG. 8 is a block diagram illustrating an example ML system 800, in accordance with one or more embodiments. Likewise, different embodiments of the ML system 800 include different and/or additional components and are connected in different ways. The ML system 800 is sometimes referred to as an ML module.

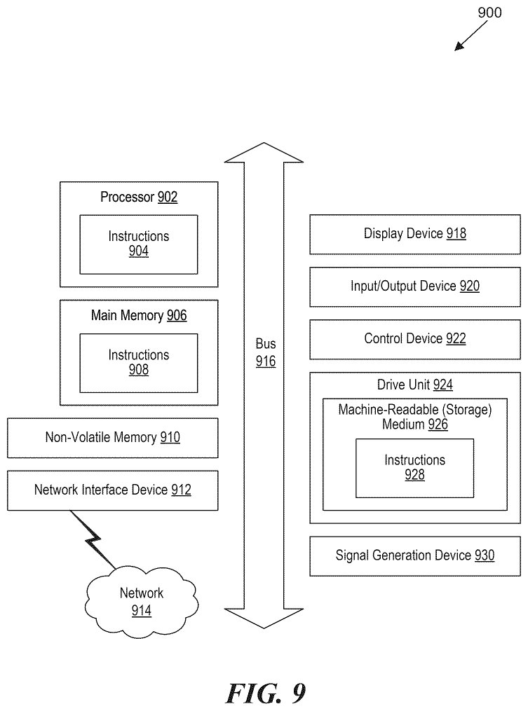

The ML system 800 includes a feature extraction module 808 implemented using components of the example computer system 900 illustrated and described in more detail with reference to FIG. 9. In some embodiments, the feature extraction module 808 extracts a feature vector 812 from input data 804. The feature vector 812 includes features 812a, 812b,. 812n. The feature extraction module 808 reduces the redundancy in the input data 804, for example, repetitive data values, to transform the input data 804 into the reduced set of features 812, for example, features 812a, 812b,. 812n. The feature vector 812 contains the relevant information from the input data 804, such that events or data value thresholds of interest are identified by the ML model 816 by using a reduced representation. In some example embodiments, the following dimensionality reduction techniques are used by the feature extraction module 808: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 816 performs deep learning (also known as deep structured learning or hierarchical learning) directly on the input data 804 to learn data representations, as opposed to using task-specific algorithms. In deep learning, no explicit feature extraction is performed; the features 812 are implicitly extracted by the ML system 800. For example, the ML model 816 uses a cascade of multiple layers of nonlinear processing units for implicit feature extraction and transformation. Each successive layer uses the output from the previous layer as input. The ML model 816 thus learns in supervised (e.g., classification) and/or unsupervised (e.g., pattern analysis) modes. The ML model 816 learns multiple levels of representations that correspond to different levels of abstraction, wherein the different levels form a hierarchy of concepts. The multiple levels of representation configure the ML model 816 to differentiate features of interest from background features.

In alternative example embodiments, the ML model 816, for example, in the form of a convolutional neural network (CNN), generates the output 824, without the need for feature extraction, directly from the input data 804. The output 824 is provided to the computer device 828. The computer device 828 is a server, computer, tablet, smartphone, smart speaker, etc., implemented using components of the example computer system 900 illustrated and described in more detail with reference to FIG. 9. In some embodiments, the operations performed by the ML system 800 are stored in memory on the computer device 828 for execution. In other embodiments, the output 824 is displayed on an electronic display of the computer device 828.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 816 is a CNN that includes both convolutional layers and max pooling layers. For example, the architecture of the ML model 816 is “fully convolutional,” which means that variable-sized sensor data vectors are fed into it. For convolutional layers, the ML model 816 specifies a kernel size, a stride of the convolution, and an amount of zero padding applied to the input of that layer. For the pooling layers, the ML model 816 specifies the kernel size and stride of the pooling.

In some embodiments, the ML system 800 trains the ML model 816, based on the training data 820, to correlate the feature vector 812 to expected outputs in the training data 820. As part of the training of the ML model 816, the ML system 800 forms a training set of features and training labels by identifying a positive training set of features that have been determined to have a desired property in question, and, in some embodiments, forms a negative training set of features that lack the property in question.

The ML system 800 applies ML techniques to train the ML model 816, that when applied to the feature vector 812, outputs indications of whether the feature vector 812 has an associated desired property or properties, such as a probability that the feature vector 812 has a particular Boolean property, or an estimated value of a scalar property. In embodiments, the ML system 800 further applies dimensionality reduction (e.g., via linear discriminant analysis (LDA), PCA, or the like) to reduce the amount of data in the feature vector 812 to a smaller, more representative set of data.

In embodiments, the ML system 800 uses supervised ML to train the ML model 816, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 832 is formed of additional features, other than those in the training data 820, which have already been determined to have or to lack the property in question. The ML system 800 applies the trained ML model 816 to the features of the validation set 832 to quantify the accuracy of the ML model 816. Common metrics applied in accuracy measurement include Precision and Recall, where Precision refers to a number of results the ML model 816 correctly predicted out of the total it predicted, and Recall is a number of results the ML model 816 correctly predicted out of the total number of features that had the desired property in question. In some embodiments, the ML system 800 iteratively re-trains the ML model 816 until the occurrence of a stopping condition, such as the accuracy measurement indication that the ML model 816 is sufficiently accurate, or a number of training rounds having taken place. In embodiments, the validation set 832 includes data corresponding to confirmed locations, dates, times, activities, or combinations thereof. This allows the detected values to be validated using the validation set 832. The validation set 832 is generated based on the analysis to be performed.

### Computer System

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A device comprising:
at least one hardware processor; and
at least one non-transitory memory storing instructions, which, when executed by the at least one hardware processor, cause the device to:
receive error code data from a plurality of network nodes configured to manage mobility in a telecommunications network,
wherein the error code data is associated with signaling procedures of the plurality of network nodes configured to manage mobility in the telecommunications network;
identify, using one or more machine learning models, one or more error codes in the error code data based on at least one of a Call Final Class Qualifier (CFCQ) or a Supplemental CFCQ (SCFCQ) associated with one or more procedure types of the signaling procedures;
determine an anomaly score for each of the one or more identified error codes,
wherein the anomaly score indicates a measure of occurrences of the error code as compared to an anomaly threshold value; and
calculate, based on the anomaly threshold value and the anomaly score, a severity score for each of the one or more identified error codes.

2. The device of claim 1, wherein the one or more machine learning models are trained to determine a frequency of occurrence of an error code based on:
grouping error codes based on the one or more procedure types associated with the signaling procedures of the plurality of network nodes; and
classifying the grouped error codes into different categories based on frequencies of occurrences of the error codes.

3. The device of claim 1, wherein the device is caused to calculate the severity score based on dividing the anomaly score by the anomaly threshold value.

4. The device of claim 1, wherein the instructions further cause the device to:
generate an alert based on the severity score.

5. The device of claim 1, wherein the plurality of network nodes includes at least one of an access and mobility management function (AMF) or a mobility management entity (MME).

6. The device of claim 1, wherein the one or more machine learning models are trained to:
calculate an average frequency of each error code production type for each category,
wherein the average frequency is greater than or equal to zero.

7. The device of claim 6, wherein the one or more machine learning models are further trained to:
calculate the anomaly threshold value based on the average frequency for each error code production type.

8. The device of claim 1, wherein the instructions further cause the device to:
provide a user interface indicating at least one of the anomaly threshold value, the anomaly score, or the severity score for each grouped error code.

9. A method for training one or more machine learning models for use in a telecommunications network, comprising:
collecting error codes from a plurality of network nodes configured to manage mobility in a telecommunications network,
wherein the error codes indicate errors associated with signaling procedures in connection with the plurality of network nodes within a predetermined time period;
generating a training dataset based on:
grouping the error codes based on one or more procedure types of the signaling procedures,
wherein the one or more procedure types are associated with at least one of a Call Final Class Qualifier (CFCQ) or a Supplemental CFCQ (SCFCQ); and
categorizing the grouped error codes into different categories based on frequencies of occurrences of the error codes;
generating a supplemental training dataset based on known anomalies in the error codes; and
training the one or more machine learning models using the training dataset and the supplemental training dataset.

10. The method of claim 9, wherein the grouped error codes are categorized as:
very high count,
high count,
medium count, and
low count.

11. The method of claim 9, wherein categorizing the grouped error codes further comprises:
calculating an average frequency of each error code production type for each category,
wherein the average frequency is greater than or equal to zero.

12. The method of claim 11, wherein the average frequency for each error code varies by a procedure type.

13. The method of claim 9, wherein the plurality of network nodes includes an access and mobility management function (AMF) or a mobility management entity (MME).

14. The method of claim 9, wherein the one or more machine learning models use at least a random cut forest algorithm.

15. The method of claim 9, wherein generating the training dataset further comprises:
performing noise reduction on the collected error codes by adjusting a cluster size for classifying the training dataset based on a procedure type.

16. The method of claim 9, further comprising:
training the one or more machine learning models to calculate a severity score for each error code,
wherein the severity score is indicative of an instance of an anomaly in the error codes.

17. The method of claim 9, further comprising:
training the one or more machine learning models to calculate an anomaly threshold value for each production type; and
training the one or more machine learning models to calculate an anomaly score for each error code,
wherein a severity score is calculated using the anomaly threshold value and the anomaly score.

18. A system comprising:
a plurality of network nodes configured to manage mobility in a telecommunications network,
wherein the plurality of network nodes is configured to generate error code data upon detecting issues with signaling procedures handled by the plurality of network nodes; and
a controller network node comprising one or more machine learning models configured to:
identify one or more error codes in the error code data based on at least one of a Call Final Class Qualifier (CFCQ) or a Supplemental CFCQ (SCFCQ) associated with one or more procedure types of the signaling procedures;
determine an anomaly score for each of the one or more identified error codes,
wherein the anomaly score indicates a measure of occurrences of the error code as compared to an anomaly threshold value; and
calculate, based on the anomaly threshold value and the anomaly score, a severity score for each of the one or more identified error codes.

19. The system of claim 18, wherein the plurality of network nodes includes at least one of an access and mobility management function (AMF) or a mobility management entity (MME).

20. The system of claim 18, wherein the controller network node is further configured to provide:
a user interface indicating at least one of the anomaly threshold value, the anomaly score, or the severity score for each grouped error code.
